(19) United States
(12) Patent Application Publication
(10) Pub. No.: US 2012/0120755 A1
(43) Pub. Date: May 17, 2012

(54) Beater attachment for use in commercial food mixers

(75) Inventors: Gary Scott Fallowes, San Diego, CA (US); William Tan, Singapore (SG)

(73) Assignee: Shelter Rock, LLC

(21) Appl. No.: 12/927,409

(22) Filed: Nov. 15, 2010

(51) Int. Cl. B01F 7/16

(52) U.S. Cl. 366/312

(57) ABSTRACT

A scraper attachment used with a food mixer made up of a plurality of elongated segments wherein each of said segments have a different degree of flexibility so that in operation food ingredients located in the mixing bowl is directed to the middle of the bowl

### BACKGROUND OF THE INVENTION

The subject invention is in the field of stand food mixers to be utilized in a commercial setting and more particularly to the attachment for the mixer that mixes the food in the mixer bowl.

Commercial standing food mixing can be traced to the early 1900's when the Hobart Manufacturing company began offering 80 quart mixers to professional bakers. Since then there have been few major developments in mixers that are used in the commercial sector.

### DISCUSSION OF PRIOR ART

The food mixing implement that is referred to in this prior art section of the disclosure as the “flat beater” is a rotating attachment to the most popular commercial food mixers.

There have been no significant improvements to the flat beater.

An example of the state of the prior art is found in the disclosure of U.S. Pat. No. 4,946,285 wherein a typical prior art flat beater is utilized along with an added food scraper. The food scraper is necessary to overcome the deficiencies that is found using the ‘285’ flat beater as explained below:

The flat surface arms of the flat beater agitates the food as it rotates without scraping said food from the side of the mixing bowl. Therefore, as the beater 18 rotates the food tends to build up and stick to the sides of the bowl. When this occurs the operator of the mixer has to stop the mixing process, lower the bowl, scrape the food stuffs away from the side of the bowl, return the bowl to the up position and activate the mixer. In a typical batch mixing session this process can occur several times resulting in a waste of time and energy.

Further, the use of a flat beater often results in clumps of flour and unincorporated food stuffs being left at the very bottom of the bowl creating a non-homogeneous mixture. Such non-homogeneous mixture results in uneven cooking or, worse, unusable baked food products.

In the preparation of a mixture to make “compound butter” the items to be mixed must be thoroughly whipped or aerated. The use of the flat beater takes an inordinate amount of time to achieve the correct consistency of the batter mix.

Generally, the prior art flat beaters when used for mixing cold fatty mixtures having butter or cream cheese and the like cannot achieve the required pasty consistency resulting in undesirable clumps of unmixed food and an unsatisfactory

cooked product.

In an attempt to overcome the deficiencies of the flat beaters found in the prior art various additions to the mixing process was developed.

A good example of one such development is the use of a food scraper attachment as particularly described in the ‘285’ patent.

The use of such a scraper results in the following negatives:
The mixing bowl must be empty prior to raising bowl into mixing position. The operator cannot raise the bowl into position with food already in it without subjecting the scraper arm from bending and becoming permanently damaged. In the event there is food in the bowl, the operator must run the mixer while raising the bowl into position causing safety concerns.
Tools are required to assemble and permanently attach the receiving mechanism of the scraper onto the mixer head.
The additional cost for the scraper arm, receiving mechanism and required tools are prohibitive.
The spinning of the scraper arm makes adding ingredients during the mixing procedure difficult and dangerous to the operator,
A “bowl splash guard” cannot be used
Pre-lubrication of the bowl surface with vegetable oil or shortening prior to adding ingredients is required. The area above the product where the sleeve might rub against the bare surface of the bowl is an especially important concern.

### BRIEF SUMMARY OF THE INVENTION

An object of the invention is to provide a new and improved beater that overcomes the disadvantages enumerated above. Specifically, the beater that is the subject of this invention is provided with:
Improved aerodynamic design of the arms of the beater to provide a cutting edge surface.
Removable food scraper blades.
A changing angle of the scraper blade with respect to the bowl wherein the angle is increased from the bottom to the top to accommodate the shallow structure of the bottom of the bowl.
An intermittent bowl scraping action.
Unique scrapper blades shaped for scooping the ingredients.
Snapability of the scraper blades to provide a flicking action of the food in the bowl towards the center of the bowl.
Unique positioning of the attachment mechanism of the scraper blades.

The above features will be explained in conjunction with the drawings and in the detailed description of the invention below.

### BRIEF DESCRIPTION OF THE DRAWING

FIG. 1 is a plan view of the inventive beater blade.

FIG. 2 is another view of the beater blade.

FIG. 3 is a view of the scraper blade.

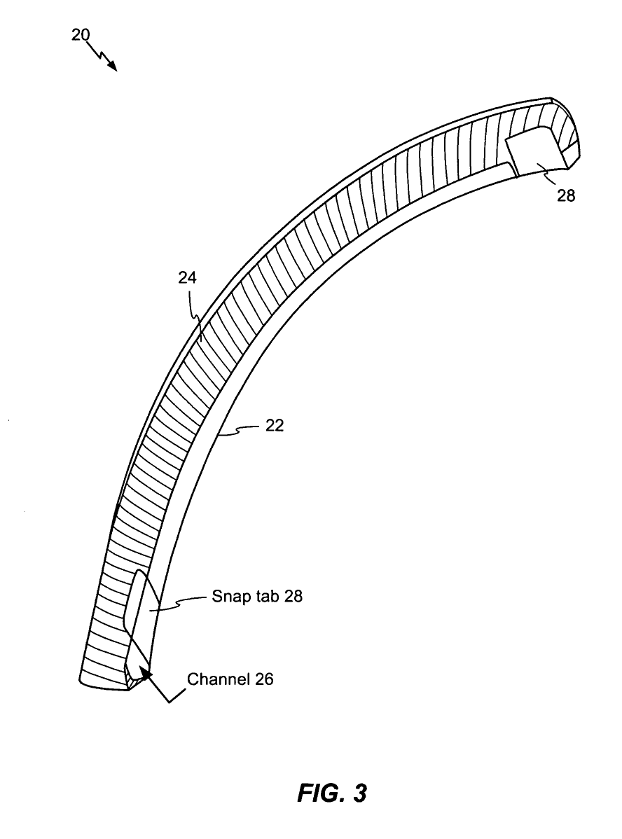

FIG. 4 is a depiction of the curvature of the blade.

FIG. 5 is a cross-section of the scraper blade.

FIG. 6 is a view of an alternative embodiment of the scraper blade.

### DETAILED DESCRIPTION OF THE INVENTION

The inventive “beater blade” 1 is designed with improvements to replace all prior art blade including the blade and bowl scraper disclosed in U.S. Pat. No. 4,946,285 and incorporated in this disclosure by reference. The food mixer disclosed therein is directed to commercial models of the planetary type wherein a cylindrical bowl is stationarily supported and a rotating beater moves in an orbit within the bowl around the interior circumference of that bowl.

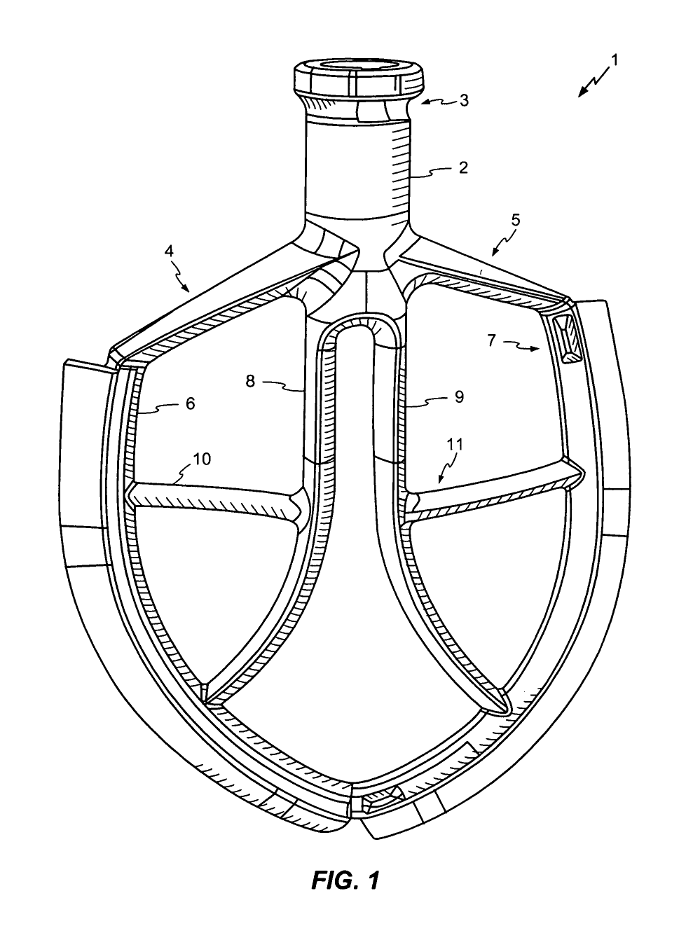

As best seen in FIG. 1 beater blade 1 has a neck 2 the upper end of which has a slotted portion 3. A cross pin drive is provided on the end of the mixer beater shaft. Blade 1 is removeably mounted to the mixer by the insertion of the cross pin drive into the slotted portion 3. Once the beater is mounted it can rotate in the same manner as the blade shown in the ‘285’ patent.

Extending in opposing substantially horizontal directions from the bottom of neck 2 are arms 4 and 5. At the far ends of arms 4 and 5 are downwardly extending respective segments 6 and 7. Segments 6 and 7 are curved to match the general shape of the interior side walls of the bowl so that the ends thereof meet at the bottom area of the bowl. Segments 8-11 are support members giving extra strength to blade 1. Members 2-11 are provided from a one-piece structure for ease of manufacture and to provide maximum strength capabilities.

Due to the high torque requirements of commercial food mixers the material used for beater blade 1 is metal. In the preferred embodiment the metal of choice is aluminum. Segments 4, 5, and 8-11 are each provided with an aerodynamically shaped leading cutting edge. This design is in contrast to the flat surface leading edge of the prior art flat blades as shown in the ‘285’ patent and results in the capability of the arms of the blade to more easily cut through the food in the bowl as beater blade 1 rotates.

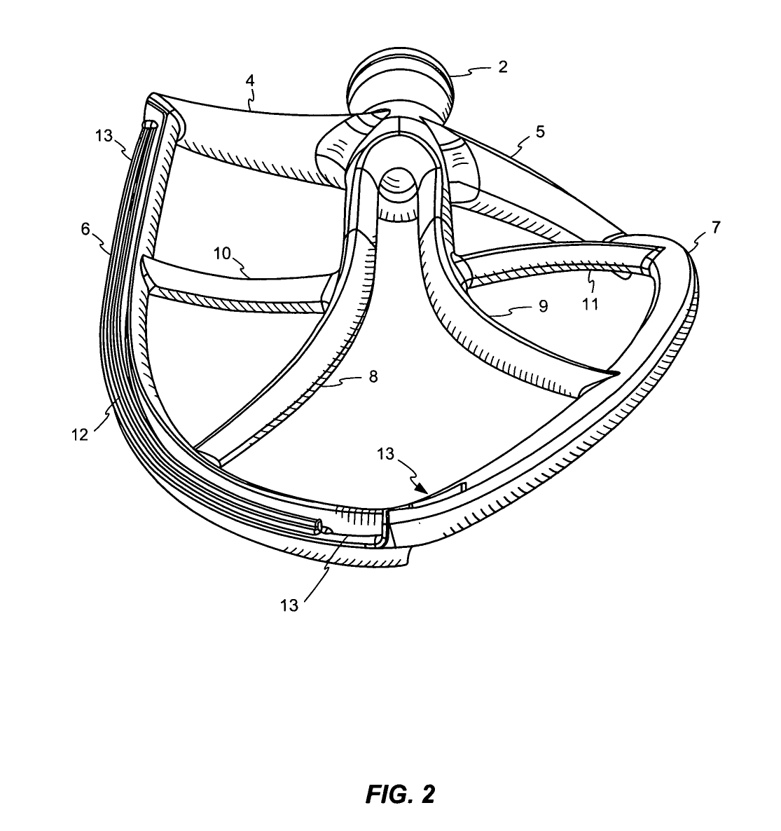

Referring more particularly to segments 6 and 7 in FIG. 2 it can be seen that the exposed side of segment 6 shows a channel 12 and the exposed side of segment 7 shows an even surface. It should be understood that the unexposed side of segment 7 also has a channel 12 and that the unexposed side of segment 6 has a similar flat surface as the exposed side of segment 7. Channel 12 on the exposed side of segment 6 and the unexposed side of segment 7, as will be explained below in better detail is structured to mate with removable scraper blades 20. In addition, both segments 6 and 7 are provided with cut out portions 13, the function of which is explained below.

Scraper blade 20 is constructed of a hard plastic segment 22 molded to a flexible plastic segment 24 which has a durometer rating that achieves a ‘snap’ or ‘flick’ action so as to throw the food into the center of the bowl for further mixing. If the material for segment 24 is too soft, the action results in a ‘licking’ of the food with no positive action. This combination of material and desired durometer rating provides the necessary flexibility needed for segment 24 to achieve a successful operation of beater blade 1 while plastic segment 22 provides the necessary hardness required for a strong and sturdy support and reliable mounting of scraper blade 20 onto beater blade 1.

Channel 26 on scraper blade 20 is designed to interlock with channel 12 on segments 6 and 7 ensuring a stable mating of scraper blade 20 with segments 6 and 7. Snap tabs 26 formed on plastic segment 22 are provided to releasably force fit into cut out portions 13 on segments 6 and 7.

As explained above beater blade 1 is utilized as a replacement of the blade and scraper attachments described in the '285 patent. In operation, the bowl is lowered so that beater blade 1 can be mounted as is shown in the ‘285’ patent. With blade 1 mounted to the mixer blades 20 are positioned in a substantially vertical orientation with the bottom thereof being closest to the bottom of the mixing bowl.

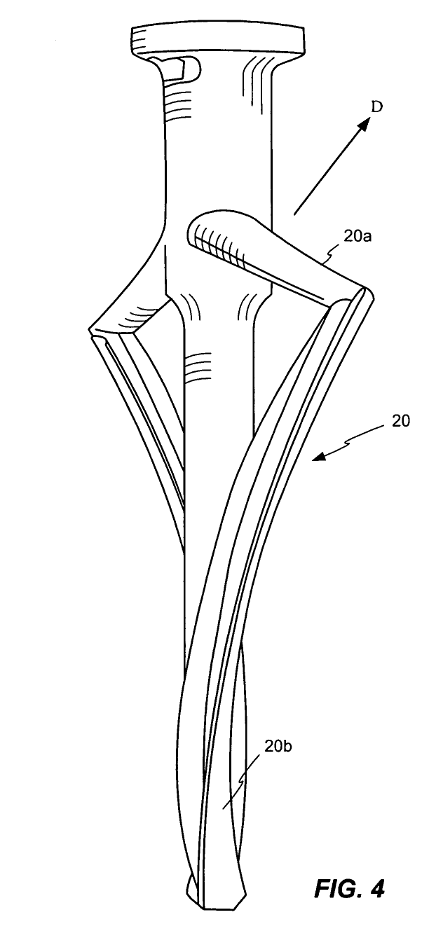

In the mounted vertical direction blades 20 conform in shape to at least a portion of the top to bottom contour of a typical mixing bowl. In addition, blades 20 are curved in a horizontal direction. This representation of the horizontal can best be seen in FIG. 4 wherein segment portion 20a is located on the upper portion of blade 20 and is horizontally ahead of the bottom positioned segment portion 20b relative to the counter-clock direction D with blade 20 being gently curved backward (relative to the direction of rotation D) top to bottom and with a slight curve back forward in a horizontal direction near the bottom 20b as shown. Having this configuration, blade 20 effectively pushes food from the side of the bowl into the center for improved mixing as compared to the prior art blades that is not so curved in the horizontal direction.

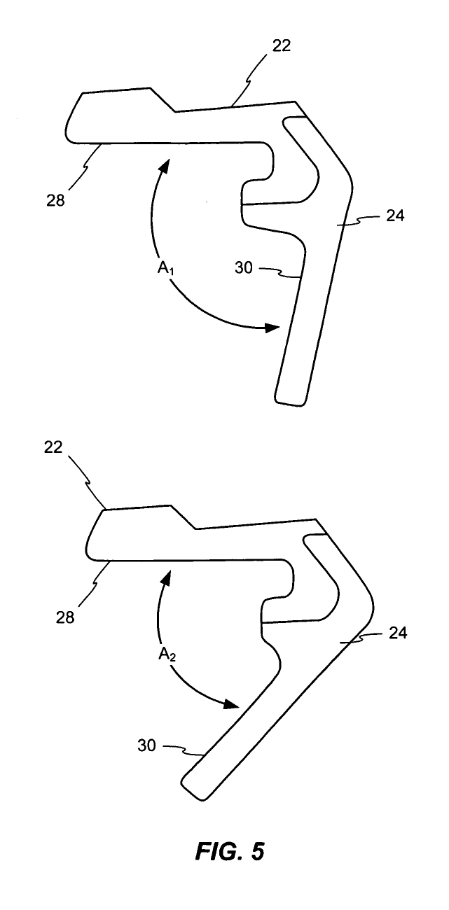

Another important design feature of scraper blade 20 is the structure of flexible plastic segment 24 and the relationship of that structure to hard plastic segment 22. This design feature is best explained by reference to the cross-section view of scraper blade 20 shown in FIG. 5. It can be seen that leg 28 of segment 22 in FIG. 5 form angles A1 and A2 with leg 30 of segment 24. When attached to beater blade 1 the upper end of scraper 20 angle A1 will have a predetermined starting value of less than 90 degrees. At the other or lower portion of scraper 20 the value of angle A2 will be less than the value of the upper angle A1. The change in the value of angle A from top to bottom decreases on a continuous basis. The importance of this design feature is explained below in conjunction with the explanation of the operation of the mixing operation.

When scraper blade 20 is force fit unto beater blade 1 by the insertion of tabs 28 into the openings 13 the cross-section of scraper blade 20 at its bottom end will have the smallest angle A referred to in FIG. 5 as angle A2. It is to be understood that this lowest point is the location that comes into contact with the bottom of the mixing bowl as the bowl is raised into position to begin the mixing operation. The value of angle A continuously increases until the cross section reaches its maximum, angle A1 at the top end of scraper blade 20. It has been determined that the small value of angle A is necessary in order to prevent tabs 28 from being forced out of openings 13 when it makes contact with the bottom of the bowl. The increased angle A on the upper portion of blade 20 is important to provide the capability of the blade to throw the food from the side of the bowl to the center in a snap or flick motion.

The raising of the bowl to the mixing position causes a deformation of the portion of rubber segment 22 closest to the bottom of the bowl. The position of tabs 28 in cut out portions 13 acts to lock scraper blade 20 to segments 6 and 7 during the bowl raising operation.

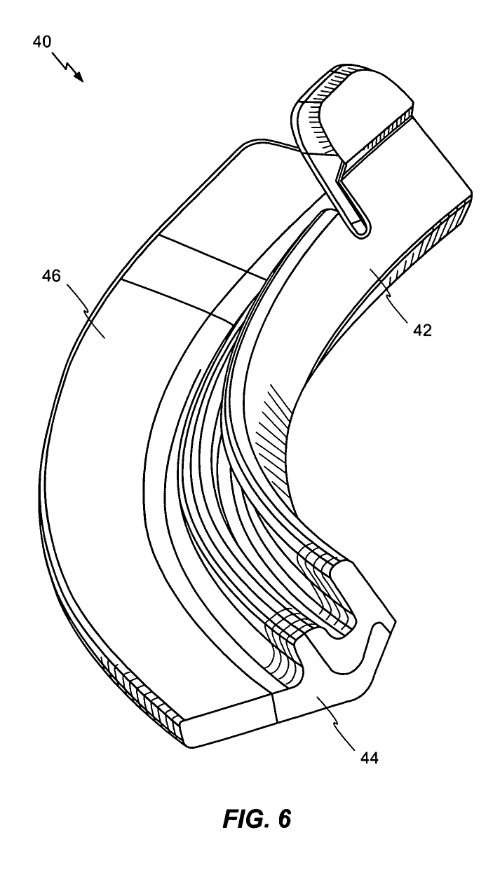

An alternative scraper blade structure is depicted in FIG. 6 wherein scraper blade 40 is shown to be constructed of three plastic segments 42, 44 and 46. Each of the plastic segments 42, 44 and 46 has a unique degree of flexibility. Segment 42 is the least flexible. Segment 44 is the most flexible. The three segments are permanently molded together as shown in FIG. 6 to form a wider scraper blade 40 than that of scraper blade 20. This structure results in a scraper blade that can be controlled and manipulated to reduce the wear and tear of the blade in a manner more favorable than the two segment blade 20. The increased width of blade 40 provides increases overall flexibility and an increased width to accommodate mixing bowls that are not perfectly round.

It is to be understood that segment 42 has the same channel and snap tabs as scraper blade segment 22 of the two segment scraper blade 20.

1. An attachment for use in conjunction with a food ingredient mixing apparatus in which the food ingredients are located in a mixing bowl wherein the main body of said attachment is a one piece member upon which removable scraper means are mounted, said scraper means comprising two elongated plastic segments permanently attached to each other so that when attachment is utilized to mix said food ingredients located in said mixing bowl said scraper means pushes said food ingredients away from the inner wall of said mixing bowl towards the middle portion of said bowl.

2. The attachment of claim 1 wherein one of said elongated plastic segments of said scraper means is less flexible than the other.

3. The attachment of claim 1 wherein said elongated plastic segments are molded together to form a permanent bond.

4. The attachment of claim 2 wherein said elongated plastic segments are molded together to form a permanent bond.

5. The attachment of claim 1 wherein the cross-section of said scraper means continuously changes from one end thereof to the other.

6. The attachment of claim 2 wherein the cross-section of said scraper means continuously changes from one end thereof to the other.

7. The attachment of claim 4 wherein the cross-section of said scraper means continuously changes from one end thereof to the other.

8. The attachment of claim 2 wherein two portions of said flexible segment of said scraper means form an angle with each other said angle being smaller at one end of said scraper means then the other.

9. A scraper attachment for use in the food ingredient mixing environment comprising more than two elongated plastic segments permanently attached to each other so that when said scraper attachment is utilized to mix food ingredients located in a mixing bowl said scraper attachment pushes said food ingredients away from the inner wall of said mixing bowl towards the middle portion of said bowl.

10. The attachment of claim 9 wherein one of said elongated plastic segments of said scraper attachment less unbendable then the others having a udometer measurement of a pre-determined value.

11. The attachment of claim 9 wherein the cross-section of said scraper attachment continuously changes from one end thereof to the other.

12. The attachment of claim 10 wherein the cross-section of said scraper attachment continuously changes from one end thereof to the other.

13. The attachment of claim 10 wherein said flexible segments of said scraper attachment form an angle such that said angle is smaller at one end of said scraper means then the other.
